(19) United States
(12) Patent Application Publication
(10) Pub. No.: US 2018/0118618 A1
(43) Pub. Date: May 3, 2018

(54) METHOD OF PRODUCING CONCRETE FROM WASTE MATERIAL AND WASTE-BASED CONCRETE MADE USING SAID METHOD

(71) Applicant: Karoly Bus, Budapest (HU)

(72) Inventor: Karoly BUS, Budapest (HU)

(21) Appl. No.: 15/572,187

(22) PCT Filed: May 3, 2016
(86) PCT No.: PCT/HU2016/000027

§ 371 Date: Nov. 7, 2017

(30) Foreign Application Priority Data
May 8, 2015 (HU) P1500224

(51) Int. Cl. C04B 18/04; C04B 28/02; C04B 14/06; C04B 14/04; C04B 14/36; C04B 24/24; C04B 18/22; C04B 18/30; C04B 18/24; C04B 18/20; C04B 18/14

(52) U.S. Cl. CPC C04B 18/04; C04B 28/02; C04B 14/06; C04B 14/04; C04B 14/361; C04B 18/141; C04B 18/22; C04B 18/305; C04B 18/0481; C04B 18/24; C04B 18/20; C04B 24/24

(57) ABSTRACT

The invention: a procedure to manufacture recycled waste concrete, and the recycled waste concrete itself, which is produced through a simple processing of various types of waste and is suitable for serving as a material to manufacture concrete products widely used in the construction industry, where such products include road bases, strip foundations, bases of houses, noise barriers, traffic barriers for highways/roads, lane separators, sandwich panels, to fill formwork and even, depending on the type of waste used, to build walls. The recycled waste concrete contains cement, water and shredded waste aggregates, such as shredded tyres and/or any shredded plastic waste, and/or any shredded scrap metal, and/or any shredded garden waste, and/or shredded mixed waste, and/or shredded fibre waste, and/or any shredded glass waste, and/or shredded and effectively neutralised municipal waste. As organic binding agent it contains homo-, co- and terpolymers, which can be dissolved and/or dispersed in water and do not contain or produce environmentally hazardous, volatile, organic hydrocarbons, and such polymers are made, for instance, by using vinyl chloride, vinyl esters of saturated, unsaturated and aromatic organic acids, vinyl butyral, ethylene, esters of acrylic acid, styrene, alkyl isocyanates, silanes and siloxanes, which may contain polyvinyl alcohols and/or cellulose ethers and/or other protective colloids. The invention is characterised by being produced by simply mixing the ingredients in the proportions given as listed below: 20-50 volume percent cement, 0.3-10 volume percent organic polymer binding agent, 8-30 volume percent water, and 50-100 volume percent shredded waste aggregate.

The invention is the procedure for producing waste material based concrete and the obtained waste based concrete itself, which, through a simple processing of different types of waste, is applicable for producing a wide range of concrete products in the construction industry, either as a new product or as the concrete made with various types of aggregates. Waste based concrete produced this way can be used in a large variety of areas in the construction industry, ranging from road bases, strip foundations, bases of houses, noise barriers, traffic barriers for highways/roads, lane separators, sandwich panels, to fill formwork for concrete walls, etc . . . or, depending on the type of waste aggregate used, even walls can be built from it.

I have considered current technologies from the perspective of waste management and from the perspective of concrete ingredients and the production of concrete products in the construction industry.

According to current technologies, it is possible to manage waste in a number of ways.

One of those is recycling, which can be done through a variety of methods, the different types of waste are separated and processed with the help of extremely different technologies and, as a result, usually the original raw material is produced, which then can be used again to make a new product. Recycling waste to produce the same raw material as it is the waste of is extremely useful, however, it is a costly and time-consuming process. The most prevalent examples for the various methods for recycling, probably, generating the least extra costs and somewhat more cost-effective than others, are to be found in the glass manufacturing industry and in the pulp and paper industry.

How about recycling waste but producing some material other than the original raw material? Lots of ideas have been put forward in this area as well, for instance the Hungarian patent application numbered P1100187 describes producing fertiliser from sewage sludge, or, to mention a completely different field, the Hungarian patent application numbered 227 336 describes producing rubber floor tiles from used tyres by shredding and gluing.

Apart from recycling, there exist methods to speed up the degradation of various types of waste, when some chemical and soil are mixed with the waste and, given some time, it degrades. The aim of the process to support degradation is to get rid of the waste, it brings no real profit, produces only costs, and even as it is it pollutes the environment.

Yet another possibility is to incinerate or crack waste, there are a number of well-known methods for these as well, but all those methods are characterised by air pollution to a large extent. Although certain more up-to-date methods for cracking have been developed, where, beside air pollution not being significant, some marketable end product may also be gained, but even so, the methods are still rather costly and complex. Furthermore, the ‘rinse water’ used in the procedure becomes badly polluted, cleaning it is an additional task as in the case of, for instance, pyrolysis, registered under and described in detail in the European Patent Register, number E017223.

Finally, yet another possibility is to store the waste or ‘deposit’ it left unprocessed or neutralized. Unfortunately, there is no profit to be made there, on the other hand, it is costly and in most cases it pollutes the environment, which is an alarming problem all over the world. In order to solve that issue there exist regulated methods, such as the process registered under the European Patent Number E07009927, where waste containing synthetic aggregates is shredded, sorted, and mixed into the soil in accordance with carefully made calculations, thereby promoting degradation.

There is no method to be found, where it is not necessary to previously treat the waste in any way, yet it allows for cost-effective recycling, and the end product is really essential and may be really widely used.

There is also a wide range of current technologies in the concrete manufacturing industry. Traditionally, the basic ingredients of concrete are cement, sand and/or gravel, and water. By changing the basic ingredients, the properties of the concrete can be tailor-made to fulfil very diverse purposes. Different types of concrete made to perform special functions are known, for instance there is so-called high-strength concrete, reinforced concrete, which may be used as part of a load-bearing element, there is a large variety of lightweight concretes, which are mostly used for insulation, there are concrete slabs or even bullet resistant concrete and radiation resistant concrete. In order to obtain such properties, often different kind of additives are used, which, apart from yielding the desired special property, also facilitate mixing and building. Such additives include water holding, anti-settling, anti-frost and homogenising or even flame retardant additives.

When mixing concrete and cement products, a variety of aggregates are used alongside sand and/or gravel, or even to replace them.

Fillers widely used in concrete include for example pearlite, special paper-mash, ceramic or polystyrene beads. This way, due to low bulk density, the result is lightweight concrete used for insulation.

For example, if the procedure registered under number 227 463 in the Hungarian Patent Registry is applied, with the inclusion of organic polymer as binding agent, an insulating, fire-retardant, low-permeability, breathable, highly elastic lightweight concrete may be manufactured, where the aggregate will contain polystyrene beads in each case. This type is closest to my invention, and it is obviously used for insulation purposes.

Although not concrete, mention must be made of simple clay and straw walls in building because of the organic aggregate they contain, rooted in a tradition thousands of years old. Clay and straw bricks are made of garden waste and clay, the mixture is ‘shovelled into a mold’, and the bricks can be used to build a house. Clay and straw brick walls, unfortunately, are not too resistant to damage caused by the environment, especially water, therefore, if the building is erected on land exposed to much rain, or on wet soil, the clay and straw wall will have a short service life, as is generally known.

Considering the most up-to-date technologies, neither through examining concrete manufacturing and manufacturing concrete products today nor through examining recycling methods have I come across a procedure which would connect the two industries in a way similar to the way my invention does. Nowadays, the construction industry uses only one type of waste aggregate, polystyrene beads, to produce concrete. However, sadly, in practice it seems that it is very hard to provide the sufficient amount of polystyrene waste for the production of polystyrene concrete. Therefore, freshly manufactured polystyrene is used, more than polystyrene waste, thus, the aim of producing polystyrene concrete is not to ‘get rid of’ polystyrene waste, rather, somewhat selfishly, to produce the type of concrete with better properties.

In the recycling industry I have observed costly and complicated procedures, in concrete manufacturing the use of specific aggregates often produced for the given purpose. There is no single patented or well-known concrete manufacturing procedure whose goal is to use as an aggregate large quantities of diverse waste types in such a way that the end product is environment-friendly and may even contain different types of waste.

The problem at hand, essentially, was to be able to invent a product for the construction industry which can be used in large quantities, serves truly important purposes and can be sold on the market, a product made from a wide range of waste types, potentially unselected, undergoing a simple treatment, which, often, would simply mean shredding the waste into small particles, at a minimum cost.

The essence of my invention, which, at the same time, is what I discovered, is that practically almost any type of waste, even in large quantities, if shredded, can serve as an aggregate if cement, water and polymer additives are simply mixed into concrete which can be widely used, depending on the actual waste type, for a variety of purposes. General properties of concretes manufactured with this method are that they are high-strength, do not crumble, watertight, so rain, snow, river, sea or groundwater will not wash any, potentially hazardous substance out of them. Moreover, if exposed to fire, the cementy material filling the voids between the grains of waste prevents the flames from spreading. Their bulk density may change on a large scale depending on the bulk density of the type of aggregate used, and the waste types can even be mixed as aggregates. Furthermore, concrete produced with this method may be shredded if necessary, and by adding cement, polymer and water it can be mixed into concrete again, and the process may be repeated infinitely. With the application of this simple procedure the recycling of waste can be much simplified, and the construction industry gains a cheap, versatile raw material.

The long-term availability through mining of the enormous amounts of gravel and sand used in the construction industry for mixing concrete is finite, the price of these raw materials is noticeably steadily rising, and although gravel and sand cannot be replaced fully in every case, some amount of waste can be used as an aggregate in concrete made for almost any purpose, which is yet another advantage of my invention.

Polymers used as additives may be homo-, co- and terpolymers, which, together with cement, if dissolved and/or dispersed in water, will serve as organic binding agent, thereby promoting the mixture of raw materials with different bulk density to form a homogenous paste in such a way that they ‘lock up’ the waste particles, so the waste will pose no further threat to the environment, and, for the same reason, the mixture is fire-resistant and the decomposition of plant particles is considerably delayed.

In the concrete made according to my invention, almost every type of shredded waste with a particle size of 0.1-100 mm in diameter can be used as an aggregate, where particle size can be changed as necessary, so the given concrete may contain the same or varying sized grains. Thus, shredded rubber tyres can be used, and it is not necessary to extract the reinforcing steel or fabric. Also, any type of shredded plastic waste can be used, where it is not necessary to extract non-plastic ingredients if there should be any, and any type of shredded scrap metal, shredded garden waste such as pine leaves, reed, construction and demolition wood waste, shredded mixed waste such as the debris left behind after extracting recyclable material when dismantling a car, shredded fabric waste, shredded glass waste, shredded and sufficiently neutralised municipal waste may also be used. In my experiments I could produce excellent quality concrete from any material that is solid enough to be shredded into particles, in other words, I have not found any material which could not serve as an aggregate.

In the concrete made according to this invention, any homo-, co- and terpolymer which can be dissolved and/or dispersed in water and does not contain or produce environmentally hazardous, volatile, organic hydrocarbons, can be used as a binding agent. Such widely known substances are made with vinyl chloride, vinyl esters of saturated, unsaturated and aromatic organic acids, vinyl butyral, ethylene, esters of acrylic acid, styrene, alkyl isocyanates, silanes and siloxanes. Further substances that may serve as organic additives are polyvinyl alcohol, cellulose ethers and other protective colloids, anti-settling agents, and plasticisers.

Thus, a general description of the invention is as follows: it is a procedure for manufacturing waste material based concrete by mixing 20-50 volume percent cement, 8-30 volume percent water, 50-100 volume percent shredded waste such as shredded rubber tyres and/or any shredded plastic waste and/or any shredded scrap metal, and/or any shredded garden waste, and/or any shredded mixed waste, and/or any shredded fabric waste, and/or any shredded glass waste, and/or shredded and effectively neutralised municipal waste. As organic binding agent 0.3-10 volume percent homo-, co- and terpolymers, which can be dissolved and/or dispersed in water and do not contain or produce environmentally hazardous volatile organic hydrocarbons, are used. Such polymers are made, for instance, by adding vinyl chloride, vinyl esters of saturated, unsaturated and aromatic organic acids, vinyl butyral, ethylene, esters of acrylic acid, styrene, alkyl isocyanates, silanes and siloxanes, and may also contain polyvinyl alcohols and/or cellulose ethers and/or other protective colloids. If necessary, sand, and/or gravel and/or soil and/or some other mineral material may also be added to the mixture.

The invention also includes the concrete produced via the procedure as part of the invention, where said concrete, through simple processing of various types of waste, becomes widely applicable in the construction industry, and is suitable for manufacturing concrete products such as road bases, strip foundations, bases of houses, noise barriers, traffic barriers for highways/roads, lane separators, sandwich panels, to fill formwork and even, depending on the type of waste used, to build walls.

Among other uses, the invention can be effectively produced for example according to the proportions and ingredients described below:

### SAMPLE MIXTURE 1

Mix 250 kg of cement with 180 l of water and 8 kg of organic polymer additive in the concrete mixer. Gradually add 0.8 m3 of shredded tyre aggregate and mix till it becomes a homogenous paste.

### SAMPLE MIXTURE 2

Mix 350 kg of cement with 350 l of water and 15 kg of organic polymer additive in the concrete mixer. Gradually add 0.1 m3 of shredded and treated municipal waste and mix till it becomes a homogenous paste.

### SAMPLE MIXTURE 3

Mix 300 kg of cement with 300 l of water and 16 kg of organic polymer in the concrete mixer. Add 0.1 m3 of shredded glass, 0.1 m3 of dried and shredded garden waste, 0.1 m3 of different types of shredded plastic waste, 0.1 m3 of shredded and treated municipal waste, 0.1 m3 of shredded polyfoam waste, 0.1 m3 of blast-furnace slag and 0.1 m3 of shredded scrap metal and mix till it becomes a homogenous paste.

1. Procedure for manufacturing recycled waste concrete defined as mixing cement, water, coarse shredded waste types such as shredded tyres and/or shredded plastic waste, and/or shredded scrap metal, and/or shredded garden waste, and/or shredded mixed waste, and/or cut fibre textile fibre waste, and/or shredded glass waste, and/or shredded municipal waste, polymers as organic binding agent and, in given cases we may also add sand and/or gravel, and/or soil and/or other mineral material to the mixture.

2. Recycled waste concrete defined as manufactured with the process described in point 1, it is concrete produced through a simple processing of various types of waste and is applicable to serve as a material to manufacture concrete products widely used in the construction industry.
